(19) United States
(12) Patent Application Publication
(10) Pub. No.: US 2014/0361894 A1
(43) Pub. Date: Dec. 11, 2014

(54) SECURITY APPARATUS AND SYSTEM USING MILLIMETER-WAVE COMMUNICATIONS, AND METHOD FOR THE SAME

(71) Applicant: Electronics and Telecommunications Research Institute, Daejeon (KR)

(72) Inventors: Byoung Gun CHOI, Daejeon (KR); Tae Young KANG, Sejong (KR); Kyung Hwan PARK, Daejeon (KR)

(73) Assignee: Electronics and Telecommunications Research Institute, Daejeon (KR)

(21) Appl. No.: 14/263,433

(22) Filed: Apr. 28, 2014

(30) Foreign Application Priority Data
Apr. 26, 2013 (KR) 10-2013-0046479

(51) Int. Cl. G08B 13/00

(52) U.S. Cl. CPC G08B 13/00
USPC 340/541

(57) ABSTRACT

Disclosed are a security apparatus and a security system using millimeter-wave communications. The security apparatus comprises a sensing part comprising at least one sensor and providing a detection signal by detecting an intruder; a control part generating intruder detection information according to the provided detection signal; and a communication part transmitting an intruder detection signal including the intruder detection information through a millimeter-wave frequency band. Therefore, a wireless security system can be implemented easily only. Also, it can be made easy to install and manage a security system as compared to configuring a security system by using wired networks, and so installation cost of the security system may be reduced.

### CLAIM FOR PRIORITY

This application claims priorities to Korean Patent Application No. 10-2013-0046479 filed on Apr. 26, 2013 in the Korean Intellectual Property Office (KIPO), the entire contents of which are hereby incorporated by references.

### BACKGROUND

1. Technical Field

Example embodiments of the present invention relate to a technology for security and crime prevention, and more specifically to an apparatus and a system for security using millimeter-wave communications, and a method for security using the same.

2. Related Art

A conventional security system for inside of a building usually checks access right class assigned for each user by using Radio Frequency Identification (RFID) authentication information, and uses a method of determining whether to permit access on regions of the building or not according to a result of the checking.

Alternatively, in the conventional security system, a sensor or a camera detecting whether an entry door is opened or closed is installed in the entry door so that it can detect whether the entry door is opened or closed. Then, the detection result is transmitted to a predetermined monitoring center as text or video signals, and the monitoring center transmits information on accesses of outsiders, as text or video signals, to a terminal by using a preconfigured telephone number through a mobile communication network.

However, in the above-described conventional security system, various apparatuses should be connected to each other by wires, and so an additional communication network is required to be installed in the building. Accordingly, it becomes difficult to install and expand the security system, and it takes much installation cost. Also, there is a problem that management after installation is not easy.

### SUMMARY

Accordingly, example embodiments of the present invention are provided to substantially obviate one or more problems due to limitations and disadvantages of the related art.

Example embodiments of the present invention provide a security apparatus, using millimeter-wave communications, which enhances convenience of installation and management.

Example embodiments of the present invention also provide a security system comprising at least one security apparatus using millimeter-wave communications.

Example embodiments of the present invention also provide a security method, using millimeter-wave communication, which enhances convenience of installation and management.

In some example embodiments, a security apparatus may comprise a sensing part comprising at least one sensor and providing a detection signal by detecting an intruder; a control part generating intruder detection information according to the provided detection signal; and a communication part transmitting an intruder detection signal including the intruder detection information through a millimeter-wave frequency band.

Here, the communication part may transmit the intruder detection signal through a 60 GHz frequency band.

Here, the communication part may transmit the intruder detection signal toward a position of a target apparatus receiving the intruder detection signal by beamforming.

Here, the control part may generate, in response to the detection signal, the intruder detection information including at least one of unique information indicating a position in which the intruder is detected and time information on when the intruder is detected.

Here, when the communication part receives an intruder detection signal from another security apparatus, the communication part may relay the intruder detection signal received from the another security apparatus to a predetermined apparatus.

In other example embodiments, a security system may comprise a first security apparatus detecting an intruder and transmitting an intruder detection signal including information about the detected intruder through a millimeter-wave frequency band; and a second security apparatus relaying the intruder detection signal received from the first security apparatus to another apparatus by using a millimeter-wave frequency band.

Here, the first security apparatus and the second security apparatus may transmit the intruder detection signal through a 60 GHz frequency band.

Here, the first security apparatus may transmit the intruder detection signal to the second security apparatus by beamforming, and the second security apparatus may relay the intruder detection signal to the another apparatus by beamforming

Here, the intruder detection information may include at least one of unique information indicating a position in which the intruder is detected and time information on when the intruder is detected.

In other example embodiments, a security method may comprise detecting, by a first security apparatus, an intruder trespassing a specific region; transmitting an intruder detection signal including information about the intruder detected by the first security apparatus through a millimeter-wave frequency band; and relaying, by a second security apparatus, the intruder detection signal received from the first security apparatus to another apparatus by using a millimeter-wave frequency band.

Here, the intruder detection signal may include at least one of unique information indicating a position in which the intruder is detected by the first security apparatus, time information on when the intruder is detected by the first security apparatus, and type information of the intruder.

Here, the first security apparatus may transmit the intruder detection signal including the information about the intruder detected by the first security apparatus to the second security apparatus by beamforming

Here, the first security apparatus and the second security apparatus may transmit the intruder detection signal through a 60 GHz frequency band.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a configuration of a security apparatus according to an example embodiment of the present invention;

FIG. 2 is a flow chart illustrating an operation method of a security apparatus according to an example embodiment of the present invention;

FIG. 3 is a conceptual diagram illustrating a configuration of a security system according to an example embodiment of the present invention;

FIG. 4 is a block diagram illustrating a configuration of a monitoring center apparatus in a security system according to an example embodiment of the present invention;

FIG. 5 is a conceptual diagram explaining an operation of a security system according to an example embodiment of the present invention; and

FIG. 6 is a message sequence chart illustrating an operation of a security system according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology a ‘security system’ used in this specification may mean a system having no restriction in its implementation form. That is, the security system according to the present invention may be implemented in various forms. For example, the security system may be implemented as an independent apparatus, or as an apparatus embedded in another apparatus.

Also, in example embodiments which will be explained in the following descriptions, an example in which a security apparatus using millimeter-wave communications (mm-Wave) uses 60 GHz millimeter-wave frequency bands to perform communications will be explained. However, the frequency bands used by a security apparatus are not restricted to 60 GHz frequency bands. That is, a security apparatus according to the present invention may be configured to use any frequency band among millimeter-wave frequency bands ranged from 30 GHz to 300 GHz.

Hereinafter, a communication technology in 60 GHz frequency bands which is applied to the present invention will be explained briefly.

The 60 GHz frequency band communications may mean communications realizing a very high speed wireless transmission using a frequency bandwidth larger than 9 GHz belonging to frequency bands ranged from 57 GHz to 66 GHz among industrial scientific medial (ISM) bands, international license-exempt bands. The 60 GHz frequency bands have been used in point-to-point communications for backbone communications of an infrastructure communication network. However, interest on it is being recently increased as frequency bands suitable for Gbps-class transmission in a short-distance wireless network.

Since a large bandwidth up to several GHz may be used in the 60 GHz frequency bands, a high data rate can be achieved. Also, due to its property of strong straightness, it has advantages of strong tolerance to neighbor interferences, high security, and easiness of frequency reuse. In addition, due to short wavelength of 60 GHz frequency bands, it is possible to make various elements required for implementing transmitter or receiver compact and lightweight.

However, due to absorption by oxygen molecular and attenuation phenomenon by rainfall, 60 GHz frequency band has a disadvantage of a short propagation distance and a disadvantage that a line-of-sight (LOS) environment should be secured for communications due to its high straightness.

Meanwhile, there is an advantage of high security due to its short propagation distance and property of straightness. Thus, it has been mainly used for wireless communications in information agencies, etc. which require high security in a form of point-to-point communications.

Another advantage of the 60 GHz frequency band is that frequency reuse can be achieved easily. That is, since a radiation power decreases rapidly to a level which does not interfere other adjacent links using 60 GH frequency band as a distance of a wireless link is made longer in the 60 GHz frequency band, it becomes possible to perform communications through a plurality of wireless links in geographically neighboring sites by using the same 60 GHz frequency band. Thereby, the frequency reuse is made possible

A security apparatus and a security system, using communication properties of millimeter-wave frequency bands, are provided as example embodiments of the present invention.

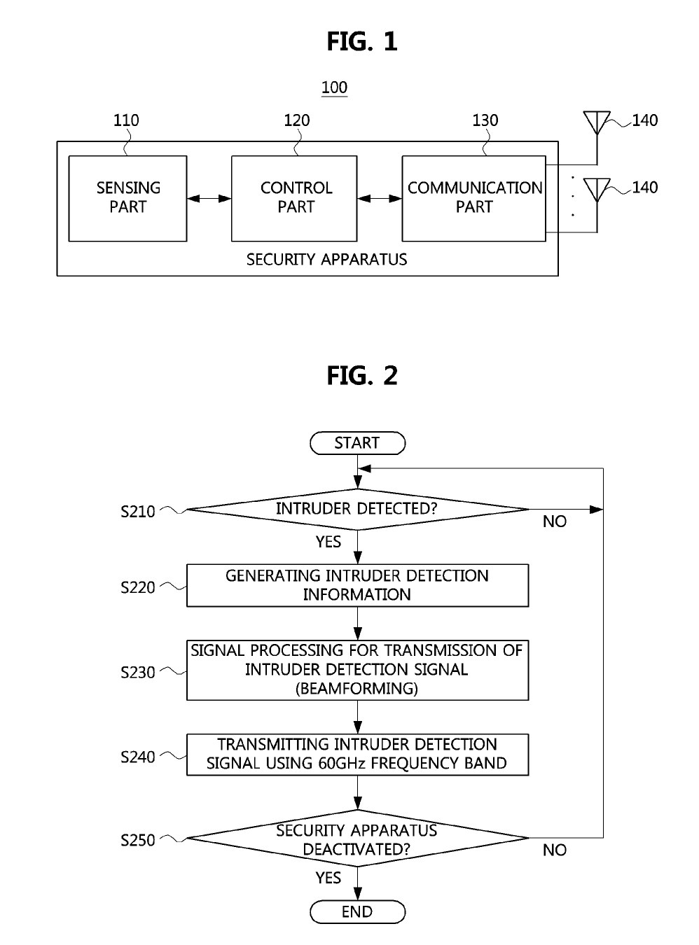

FIG. 1 is a block diagram illustrating a configuration of a security apparatus according to an example embodiment of the present invention.

Referring to FIG. 1, a security apparatus 100 according to an example embodiment of the present invention may comprise a sensing part 110, a control part 120, a communication part 130, and an antenna part 140.

The sensing part 100 may comprise at least one sensor, and provide a detection signal to the control part 120 after detecting an intruder in a region in which the security apparatus 100 is installed. For example, the sensing part 110 may comprise various types of sensors such as a motion detection sensor, an infrared sensor, a shock detection sensor, a laser sensor, a camera, etc. Also, the sensing part 110 may be activated or deactivated according to a control signal of the control part 120. Also, the sensing part 110 may comprise a single type of sensors, or various types of sensors.

The control part 120 may process and covert the detection signal into a format suitable to be transmitted through the communication part 130 after receiving the detection signal from the sensing part 110, and control the communication part 130 to transmit the processed detection signal.

That is, the control part 120 may generate intruder detection information based on the detection signal provided from the sensing part 110, and control the communication part 130 to transmit the intruder detection information.

The intruder detection information, which the control part 120 generates, may include the predefined information such as unique information indicating a region or a position in which the intruder is detected, time information about a time of detecting the intruder, a type of the intruder, etc., and the unique information, for example, may be configured to comprise a unique identification number of the security apparatus 100 or the communication part 130, a Universally Unique Identifier (UUID), or an address.

Also, when the security apparatus 100 performs a role of a relay apparatus relaying intruder detection information transmitted from another security apparatus, the control part 120 may perform controls for relaying the intruder detection information to a predetermined target security apparatus or a predetermined monitoring center apparatus.

The communication part 130 may be configured to comprise a communication module transmitting and receiving signals through 60 GHz frequency bands, and transmit an intruder detection signal including the intruder detection information provided from the control part 120 using a 60 GHz frequency band.

In order to perform communications using 60 GHz frequency bands between security apparatuses or between a security apparatus and a monitoring center apparatus, a communication part of each security apparatus may perform a pairing procedure for checking whether an adjacent security apparatus exists in a communication range or not and configuring securities.

The communication part 130 may transmit the signal by beamforming according to a position in which the security apparatus 100 is installed. For example, when obstacles such as a door, a wall, etc. exist in a transmission path through which the security apparatus 100 transmits the intruder detection signal, the communication part 130 may form a pattern of a plurality of antennas (or, array of antennas) and transmit the signal to another security apparatus or a monitoring center apparatus located in a specific direction by beamforming

Here, in order to perform beamforming, the security apparatus 100 may transmit a training sequence including unique identification information for each of a plurality of predefined beam directions, and determine a beamforming direction based on unique identification information for beamforming which is received, in response to the training sequence, from another security apparatus or a monitoring center apparatus.

Or, in the case that the security apparatus 100 receives a training sequence transmitted from another security apparatus, the security apparatus 100 may perform correlations of training sequences received from each of beam directions, obtain unique identification information corresponding to a beam direction having the highest correlation value, and transmit the obtained unique identification information to the another security apparatus.

On the other hand, when the security apparatus performs a role of a relay apparatus relaying an intruder detection signal received from another security apparatus, the communication part 130 may transmit the received intruder detection signal to a target apparatus by using an Amplify & Forward (AF) operation manner or a Decode & Forward (DF) operation manner.

Here, the Amplify & Forward operation manner is a manner in which the security apparatus 100 simply amplifies the received intruder detection signal and forwards the amplified signal to the target apparatus. On the contrary, the Decode & Forward operation manner is a manner in which the security apparatus 100 performs demodulation and decoding on the received intruder detection signal, performs modulation and encoding on the processed signal, and transmit the modulated and encoded signal to the target apparatus.

The antenna part 140 may include a plurality of antenna elements. For example, the antenna part 140 may be configured as an array of antennas.

As explained above, when a security apparatus 100 according to an example embodiment of the present invention, using millimeter-wave communications, detects an intruder, the security apparatus 100 may transmit an intruder detection signal to adjacent another security apparatus or a monitoring center apparatus by using a 60 GHz frequency band. Also, the security apparatus 100 may transmit the intruder detection signal by beamforming when there are obstacles in a transmission path of the intruder detection signal. Therefore, a security system can be constructed easily without a separate wired network for the security system.

FIG. 2 is a flow chart illustrating an operation method of a security apparatus according to an example embodiment of the present invention. The operation method illustrated in FIG. 2 may be performed by the security apparatus 100 depicted in FIG. 1.

Referring to FIG. 2, first, the security apparatus 100 may monitor whether an intruder is detected or not (S210). Here, the security apparatus 100 may determine whether an intruder is detected or not based on sensed signals, indicating detection of an intruder, generated in the sensing part 110.

If it is determined that an intruder is detected in the step S210, the security apparatus 100 may generate intruder detection information (S220). Here, the intruder detection information is information transmitted to a monitoring center apparatus, indicating detection of an intruder. For example, the intruder detection information may include information such as unique information indicating a position in which the intruder is detected, time information on when the intruder is detected, type information of the intruder, etc.

Then, the security apparatus 100 may perform signal processing for transmitting, to a predetermined target apparatus (for example, another security apparatus or a monitoring center apparatus), an intruder detection signal including the generated intruder detection information (S230). For example, the security apparatus 100 may perform processes such as modulation and encoding on a message including the intruder detection information so as to generate the intruder detection signal. Also, the security apparatus 100 may perform signal processing for beamforming when there are obstacles in a signal transmission path.

Then, the security apparatus 100 may transmit the intruder detection signal to the target apparatus using a 60 GHz frequency band (S240). Here, the security apparatus 100 may transmit the intruder detection signal by beamforming

Then, the above-described procedures may be performed repetitively until the security apparatus 100 is deactivated (S250).

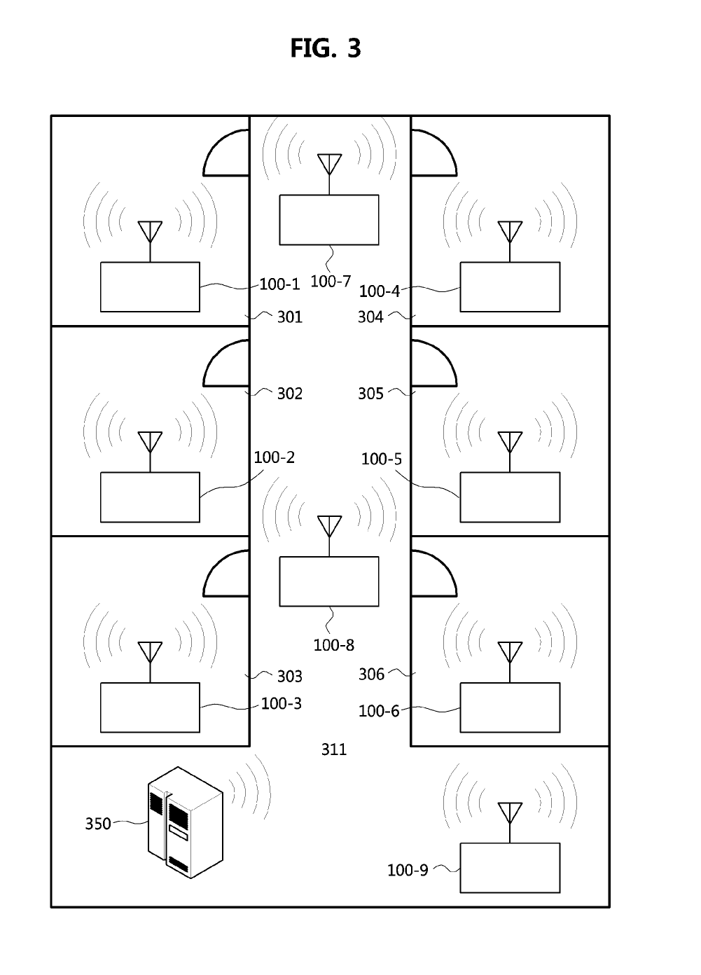

FIG. 3 is a conceptual diagram illustrating a configuration of a security system according to an example embodiment of the present invention. An example in which a security system is constructed in a building by using the security apparatuses depicted in FIG. 1 is illustrated.

Referring to FIG. 3, in a case that a plurality of separate regions 301 to 306 exist in the building and a passage 311 between the regions are formed, the security apparatuses 100-1 to 100-6, as depicted in FIG. 1, may be installed in each of the regions 301 to 306. Here, each of the security apparatuses 100-1 to 106 may be installed at a fixed point in which an intruder is easily detected in each of the regions 301 to 306, or may be installed as movable by a user.

Also, the security apparatuses 100-7 to 100-9 installed in the passage 311 may detect an intruder trespassing the 311 passage and transmit an intruder detection signal. Or, the security apparatuses 100-7 to 100-9 may receive an intruder detection signal transmitted from a security apparatus among the security apparatuses 100-1 to 100-6 installed in the regions 301 to 306, and perform a role of a relay apparatus (or, a relay node) relaying the received intruder detection signal to a predetermined target apparatus (that is, another security apparatus or a monitoring center apparatus).

On the other hand, the monitoring center apparatus 350, as a final destination apparatus which receives the intruder detection signal transmitted from a security apparatus, may be configured to be able to perform communications through a 60 GHz frequency band, and to be connected to a mobile communication network of a wireless local area network.

When the monitoring center apparatus 350 receives the intruder detection signal, the monitoring center apparatus 350 may perform a task corresponding to the received intruder detection signal in accordance with a predefined rule.

For example, the monitoring center apparatus 350 may be configured to transmit a message corresponding to the received intruder detection signal to a predetermined telephone number (for example, a user's telephone number, a telephone number of security organization, etc.), generate a warning sound such as an alarm sound, or turn on and off an warning lamp.

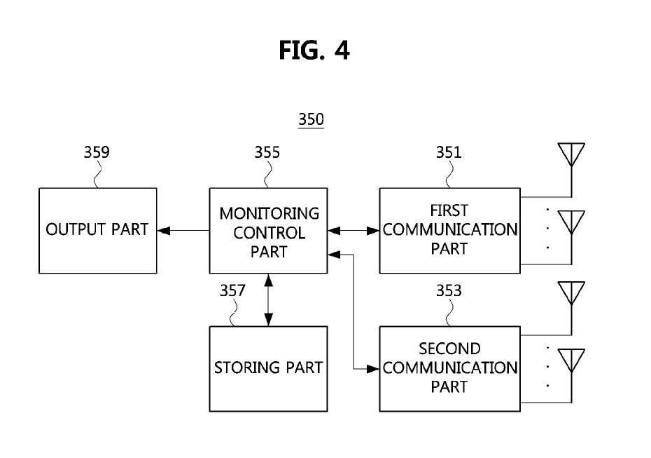

FIG. 4 is a block diagram illustrating a configuration of a monitoring center apparatus in a security system according to an example embodiment of the present invention.

Referring to FIG. 4, the monitoring center apparatus 350 may comprise a first communication part 351, a second communication part 353, a monitoring control part 355, a storing part 357, and an output part 359.

The first communication part 351 may comprise at least one antenna, and be configured to perform communications with a plurality of security apparatuses by using a 60 GHz frequency band. The first communication part 351 may receive an intruder detection signal transmitted from a security apparatus, process and covert the received intruder detection signal into a form which can be recognized by the monitoring control part to 355, and provide the processed signal to the monitoring control part 355.

The second communication part 353 may be configured with a network interface for accessing a wired network, a mobile communication network, or a wireless communication network, and transmit a message provided from the monitoring control part 355 through the connected wired network, mobile communication network, or wireless communication network. For example, the second communication part 353 may be configured with an Ethernet network card for accessing internet, with a mobile communication model for accessing the mobile communication network, or with a wireless modem for accessing the wireless communication network.

The monitoring control part 355 may check intruder detection information based on the intruder detection signal provided from the first communication part 351, transmit a message indicating that an intruder is detected to a preconfigured telephone number in response to the checked information, or control the output part 359 to generate an alarm indicating that an intruder is detected.

The storing part 357 may store information required to process a corresponding task when an intruder is detected. For example, when an intruder is detected, the storing part 357 may store information such as a telephone number of a user or a security organization corresponding to a position in which the intruder is detected.

The output part 359 may be configured with means, which can notify that an intruder is detected, such as a display apparatus, an alarm sound generator, an alarm lamp, etc. The output part 359 may be activated under control of the monitoring control part 355.

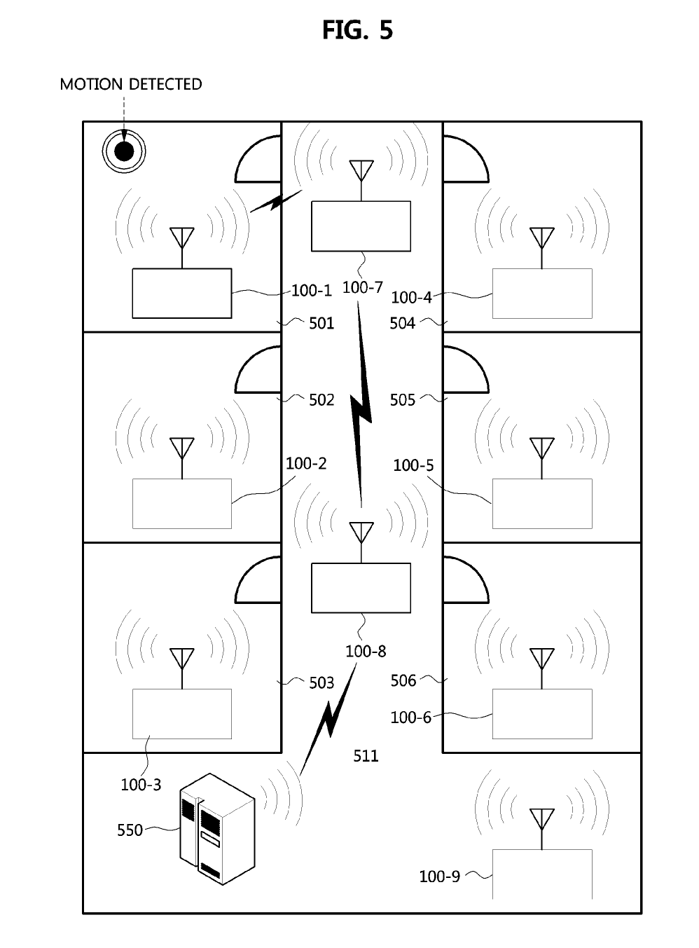

FIG. 5 is a conceptual diagram explaining an operation of a security system according to an example embodiment of the present invention. FIG. 5 shows a procedure that an intruder detection signal is transmitted to a monitoring center apparatus when a security apparatus detects an intruder.

First, as shown in FIG. 5, it is supposed that a plurality of separate regions 501 to 506 and a passage 511 are formed in a building, and each of security apparatuses 100-1 to 100-9 is installed in each of the regions 501 to 506 and the passage 511. Also, it is supposed that a first security apparatus 100-1 installed in a first region 501 is configured to detect an intruder in the first region 501.

When an intruder trespasses in the first region 501, the first security apparatus 100-1 may detect the intruder and transmit an intruder detection signal indicating that the intruder is detected to a seventh security apparatus 100-7 through a 60 GHz frequency band. Here, since there is a wall or a door between the first security apparatus 100-1 and the seventh security apparatus 100-7, the first security apparatus 100-1 may transmit the intruder detection signal toward a direction in which the seventh security apparatus 100-7 is located by beamforming

The seventh security apparatus 100-7 receives the intruder detection signal from the first security apparatus 100-1, and transmits the received intruder detection signal toward a direction in which an eighth security apparatus 100-8 is located through a 60 GHz frequency band. Here, since a line of sight (LOS) environment exists between the seventh security apparatus 100-7 and the eighth security apparatus 100-8, the seventh security apparatus 100-7 may transmit the intruder detection signal to the eighth security apparatus 100-8 without using beamforming However, since signals in 60 GHz frequency band have properties of strong straightness, an antenna gain of the signal transmitted to the eighth security apparatus 100-8 may be low due to a position of the seventh security apparatus 100-7 or an antenna part of the seventh security apparatus 100-7. In this case, the seventh security apparatus 100-7 may transmit the intruder detection signal to the eighth security apparatus 100-8 by beamforming so as to increase antenna gain of the signal.

The eighth security apparatus 100-8 may transfer the intruder detection signal received from the seventh security apparatus 100-7 to the monitoring center apparatus 550 through a 60 GHz frequency band. Here, a line of sight (LOS) environment may not exist between the eighth security apparatus 100-8 and the monitoring center apparatus 550. Accordingly, beamforming may also be used for the eighth security apparatus 100-8 to transmit the intruder detection signal to the monitoring center apparatus 550.

The monitoring center apparatus 550 may perform a task according to a predetermined rule in response to the intruder detection signal received from the eighth security apparatus 100-8.

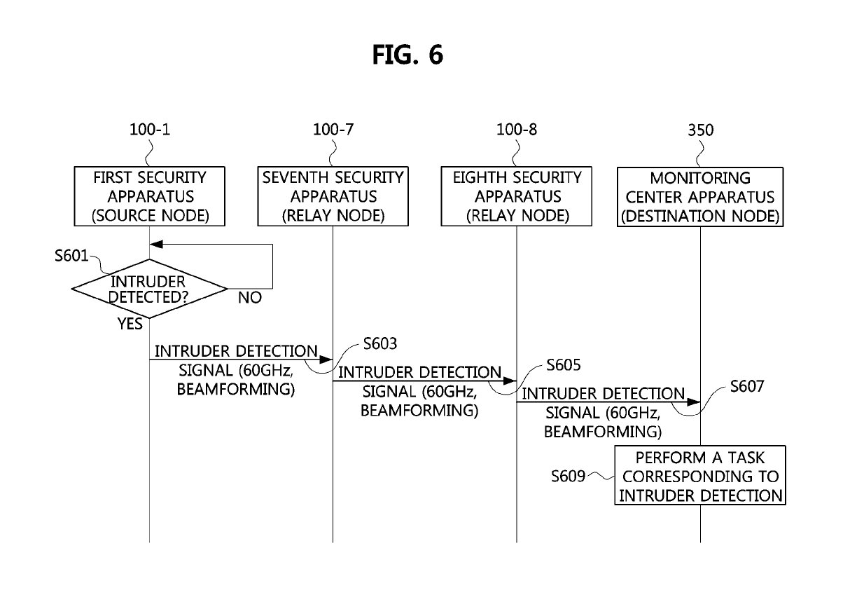

FIG. 6 is a message sequence chart illustrating an operation of a security system according to an example embodiment of the present invention.

Referring to FIG. 6, the first security apparatus 100-1 performs monitoring for detecting an intruder (S601), and transmits an intruder detection signal indicating that an intruder is detected to the seventh security apparatus 100-7 through a 60 GHz frequency band when an intruder is detected (S603). Here, the first security apparatus 100-1 may transmit an intruder detection signal toward a direction in which the seventh security apparatus 100-7 is located by beamforming That is, the first security apparatus 100-1 may perform a role of a source node transmitting an intruder detection signal.

The seventh security apparatus 100-7, which received the intruder detection signal from the first security apparatus 100-1, may transmit the received intruder detection signal toward a direction in which the eighth security apparatus 100-8, a predetermined destination apparatus, is located through 60 GHz frequency band (S605). Here, the seventh security apparatus 100-7 may transmit the intruder detection signal to the eighth security apparatus 100-8 by beamforming That is, the seventh security apparatus 100-7 may perform a role of a first relay node relaying the intruder detection signal.

The eighth security apparatus may transmit the intruder detection signal received from the seventh security apparatus 100-7 to the monitoring center apparatus 550 by beamforming through 60 GHz frequency band (S607). The eighth security apparatus 100-8 may perform a role of a second relay node relaying the intruder detection signal.

The monitoring center apparatus 550 may perform a task according to a predetermined rule in response to the intruder detection signal received from the eighth security apparatus 100-8 (S609). Here, the monitoring center apparatus 550 may perform a role of a destination node receiving the intruder detection signal finally.

As described above, according to a security apparatus and a security system using millimeter-wave communications, when the security apparatus monitors whether an intruder exists or not and detects an intruder in a specific region, the security apparatus may transmit an intruder detection signal indicating that an intruder trespasses the specific region by beamforming through a 60 GHz frequency band. The intruder detection signal transmitted from the security apparatus may be delivered to a monitoring center apparatus via relaying of at least one other security apparatus. During the relaying, a 60 GHz frequency band may also be used, and the intruder detection signal may be transmitted by beamforming.

Therefore, a wireless security system may be implemented easily only by preparing at least one sensor for detecting intruders in a communication apparatus using 60 GHz frequency bands. Accordingly, it can be made easy to install and manage a security system as compared to configuring a security system by using wired networks, and so installation cost of the security system may be reduced.

While the example embodiments of the present invention and their advantages have been described in detail, it should be understood that various changes, substitutions and alterations may be made herein without departing from the scope of the invention.

What is claimed is:

1. A security apparatus, comprising:
a sensing part comprising at least one sensor and providing a detection signal by detecting an intruder;
a control part generating intruder detection information according to the provided detection signal; and
a communication part transmitting an intruder detection signal including the intruder detection information through a millimeter-wave frequency band.

2. The apparatus of claim 1, wherein the communication part transmits the intruder detection signal through a 60 GHz frequency band.

3. The apparatus of claim 1, wherein the communication part transmits the intruder detection signal toward a position of a target apparatus receiving the intruder detection signal by beamforming

4. The apparatus of claim 1, wherein the control part generates, in response to the detection signal, the intruder detection information including at least one of unique information indicating a position in which the intruder is detected and time information on when the intruder is detected.

5. The apparatus of claim 1, wherein, when the communication part receives an intruder detection signal from another security apparatus, the communication part relays the intruder detection signal received from the another security apparatus to a predetermined apparatus.

6. A security system, comprising:
a first security apparatus detecting an intruder and transmitting an intruder detection signal including information about the detected intruder through a millimeter-wave frequency band; and
a second security apparatus relaying the intruder detection signal received from the first security apparatus to another apparatus by using a millimeter-wave frequency band.

7. The system of claim 6, wherein the first security apparatus and the second security apparatus transmit the intruder detection signal through a 60 GHz frequency band.

8. The system of claim 6, wherein the first security apparatus transmits the intruder detection signal to the second security apparatus by beamforming, and the second security apparatus relays the intruder detection signal to the another apparatus by beamforming.

9. The system of claim 6, wherein the intruder detection information includes at least one of unique information indicating a position in which the intruder is detected and time information on when the intruder is detected.

10. A security method, comprising:
detecting, by a first security apparatus, an intruder trespassing a specific region;
transmitting an intruder detection signal including information about the intruder detected by the first security apparatus through a millimeter-wave frequency band; and
relaying, by a second security apparatus, the intruder detection signal received from the first security apparatus to another apparatus by using a millimeter-wave frequency band.

11. The method of claim 10, wherein the intruder detection signal includes at least one of unique information indicating a position in which the intruder is detected by the first security apparatus, time information on when the intruder is detected by the first security apparatus, and type information of the intruder.

12. The system of claim 10, wherein the first security apparatus transmits the intruder detection signal including the information about the intruder detected by the first security apparatus to the second security apparatus by beamforming

13. The system of claim 10, wherein the first security apparatus and the second security apparatus transmit the intruder detection signal through a 60 GHz frequency band.
